(19) United States
(12) Patent Application Publication
(10) Pub. No.: US 2004/0130768 A1
(43) Pub. Date: Jul. 8, 2004

(54) System and method for diffractive image formation correction

(76) Inventors: Ralph Thoma, Augsburg (DE); Volker Melzer, Munich (DE)

Correspondence Address: Agfa Corporation, Law & Patent Department, 200 Ballardvale Street, Wilmington, MA, 01887-1069, US

(21) Appl. No.: 10/336,403

(22) Filed: Jan. 3, 2003

(51) Int. Cl. G02F 1/00; G02B 26/00; G02F 1/01

(52) U.S. Cl. 359/239

(57) ABSTRACT

An illumination modulation system for producing modulated illumination for an imaging system is disclosed. The illumination modulation system includes a first modulator and a second modulator. The first modulator receives illumination from an illumination source and produces modulated illumination. The second modulator receives modulated illumination and produces corrected modulated illumination for imaging. In various embodiments the second modulator may be passive or active.

The invention generally relates to imaging systems, and particularly relates to systems and methods for producing high quality images using light modulators such as diffractive light modulators.

### BACKGROUND OF THE INVENTION

Imaging systems employing diffractive light modulators typically include an illumination source for producing, for example, a line of laser illumination. The illumination source may include a linear array of laser diodes. The line of laser illumination may then be modulated by the light modulator to produce a plurality of picture elements (or pixels) for imaging. For example, U.S. Pat. No. 6,433,934, the disclosure of which is hereby incorporated by reference, discloses an imaging system including an illumination source, a field lens system, a light modulator, imaging optics and an imaging drum for supporting recording media.

It has been discovered that although laser diodes provide relatively inexpensive illumination sources, the illumination produced by the laser diodes and other non-coherent light sources may not always have exactly a single frequency and may not be uniform across the illumination line. Certain optical systems may be used to combine the illumination from each of the laser diodes. For example, U.S. Pat. No. 5,900,981 discloses an imaging system in which illumination from each laser diode is distributed across the active region of the light modulator. Such a system, however, may not remove illumination of a frequency that is close to but not exactly the desired frequency of the system. Frequency filters may be unsuitable for filtering unwanted frequency signals from such an illumination system if the unwanted frequency signals are very close to the desired frequency.

There is a need therefore, for an illumination system using a light modulator that provides improved image quality for imaging.

### SUMMARY OF THE INVENTION

The invention provides an illumination modulation system for producing modulated illumination for an imaging system. The illumination modulation system includes a first modulator and a second modulator. The first modulator receives illumination from an illumination source and produces modulated illumination. The second modulator receives modulated illumination and produces corrected modulated illumination for imaging. In accordance with various embodiments, the second modulator corrects for unwanted variations in intensity of the modulated illumination source resulting from differences in intensity and/or frequency of any of a plurality of laser diodes. In further embodiments, the second illumination source corrects for unwanted variations in intensity of the modulated illumination source resulting from imperfections in the first modulator, and may be either an active or a passive modulator.

### BRIEF DESCRIPTION OF THE DRAWINGS

The following description may be further understood with reference to the accompanying drawings in which:

FIG. 1 shows an illustrative diagrammatic view of an imaging system in accordance with an embodiment of the invention;

FIGS. 2A and 2B shows an illustrative diagrammatic view of an image formation correction system in accordance with an embodiment of the invention;

FIGS. 3A and 3B show illustrative diagrammatic views of ribbons of a gradient light valve modulator having a spacing of Δ₁ in accordance with an embodiment of the invention;

FIGS. 4A and 4B show illustrative graphical views of the ribbons of a gradient light valve modulator having a spacing of Δ₁ in accordance with an embodiment of the invention;

FIGS. 5A and 5B show illustrative diagrammatic views of ribbons of a gradient light valve modulator having a spacing of Δ₂ in accordance with an embodiment of the invention;

FIGS. 6A and 6B show illustrative diagrammatic views of ribbons of a gradient light valve modulator having a spacing of Δ₃ in accordance with an embodiment of the invention; and

FIG. 7 shows an illustrative diagrammatic view of an image formation correction system in accordance with a further embodiment of the invention.

The drawings are for illustrative purposes only and are not to scale.

### DETAILED DESCRIPTION OF THE PREFERRED EMBODIMENTS

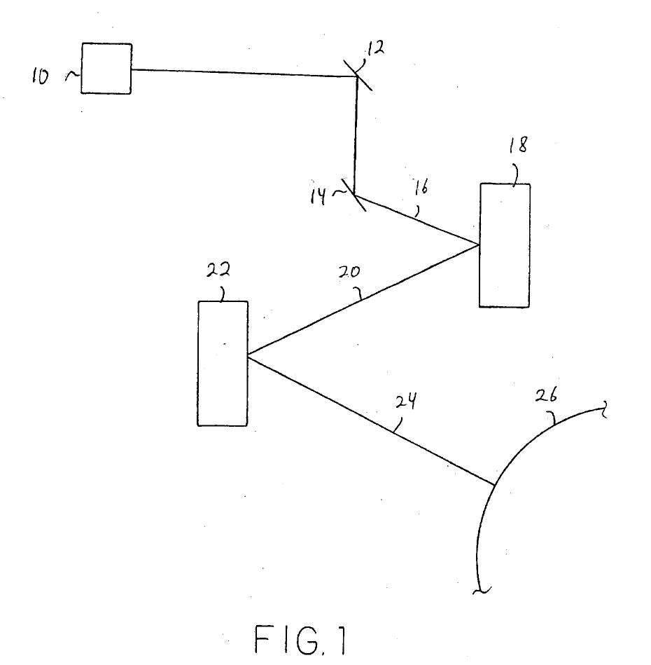

As shown in FIG. 1 an imaging system in accordance with an embodiment of the invention includes an illumination source 10 that produces an illumination field 16 that is directed by one or more mirrors 12 and 14 toward a light modulator 18 such as a grating light valve. The illumination source 10 may include a plurality of laser diodes. A modulated illumination field 20 is reflected by the light modulator 18 and is directed in this dark field arrangement toward a second light modulator 22 such as a second grating light valve. The second light modulator 22 receives the modulated illumination field 20, corrects for unwanted variations or errors in the modulated signal, and directs a corrected modulated illumination field 24 toward an imaging surface 26. Such unwanted variations or errors may include areas of reduced intensity or incorrect frequency, which results in misdirected illumination. In various embodiments, the second light modulator 22 may be a passive modulator such as a diffraction grating or an active modulator such as a grating light valve.

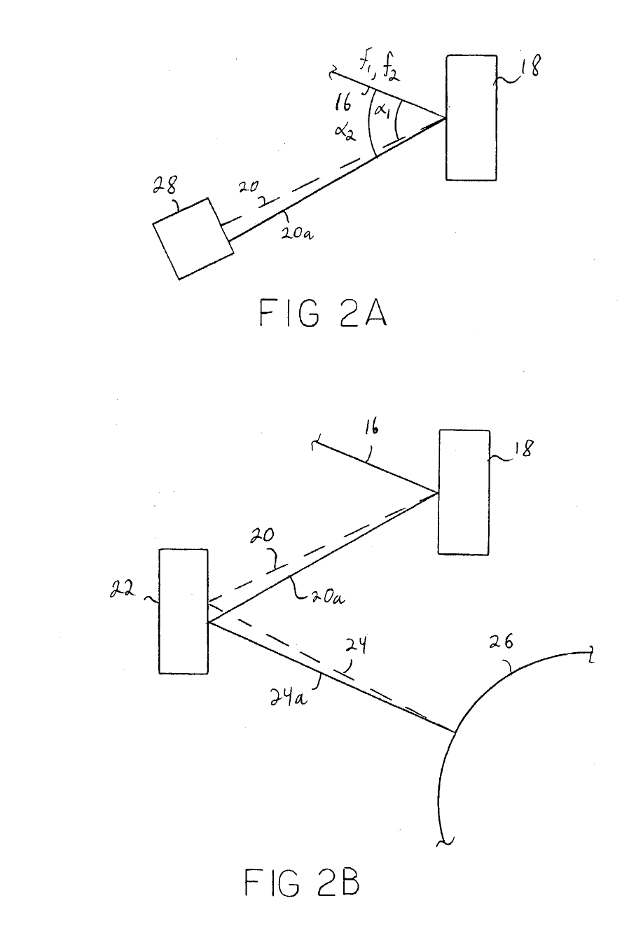

For example, as shown in FIG. 2A, the illumination field 16 may include illumination having a desired frequency ƒ₁ as well as a small amount of illumination having an undesired frequency ƒ₂. The direction of the reflected modulated illumination 20 from the modulator 18 will be produced at two angles α₁ and α₂, which vary with the frequency ƒ. Illumination 16 that includes light having of frequency of ƒ₂ therefore, will be reflected by the modulator 18 at an angle of α₂ instead of the correct angle α₁ as shown in FIG. 2A. A detector 28 may be employed to determine the extent of misdirection of the signal 20a and this information may be used to modulate the second modulator 22 to correct for the misdirection by compensation as shown in FIG. 2B. In an embodiment the information from the detector may be used to form a diffraction grating that corrects for the misdirection error. In further embodiments, a corrected modulated signal 24a is provided to the modulator 22 to direct the illumination field at the precise location on the imaging surface 26 that the correct modulated signal 24 should be received.

The correction to the modulated illumination field may be applied in a variety of ways, including adjusting the intensity of the misdirected signal to remove it from the incorrect location along the line and to increase the intensity of the modulated illumination field at the location along the line where the correct signal should be located. Another method for correcting the misdirected signal is to redirect the signal. These corrections may be achieved by adjusting the second modulator 22, for example by adjusting the spacing of the diffraction gratings.

If an active second modulator is used, the corrections may be achieved by adjusting the period or spacing of the ribbons on the light valve. The period of spacing of the ribbons on the light valve 22 with respect to the angle of reflection is provided by:

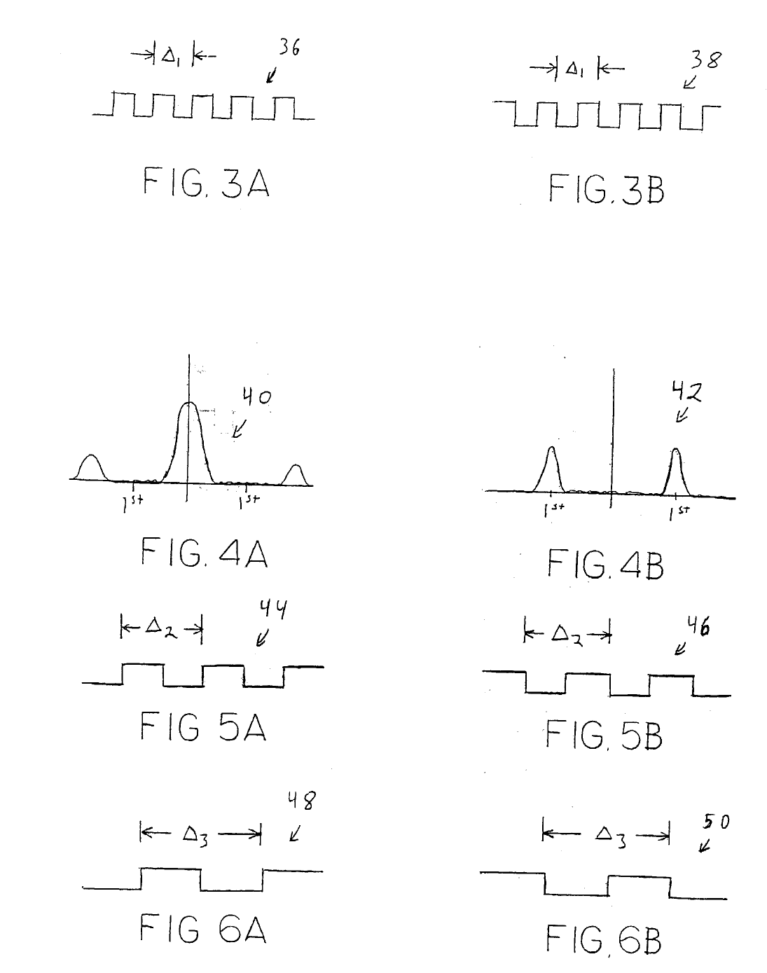

Δ=kλᵢ/sin αᵢ

where Δ is the period of the spacing of ribbons of the light valve 18, k is the order of reflection, λᵢ is the wavelength of the illumination signal having a frequency ƒᵢ and αᵢ is the angle of reflection of the illumination signal having a frequency ƒᵢ. The modulator may provide a grating period of Δ₁ and be switchable as shown at 36 and 38 in FIGS. 3A and 3B respectively. In particular, when the grating appears as shown at 36 in FIG. 3A the response to a signal having a frequency ƒ₁ may be as shown at 40 in FIG. 4A including virtually no response in the first order, whereas when the grating appears as shown at 38 in FIG. 3B the response may be as shown at 42 in FIG. 4B including a strong first order response. The intensity of the first order response may be adjusted between the levels shown in FIGS. 4A and 4B by adjusting the grating light valve to a position intermediate the positions as shown in FIGS. 3A and 3B.

As shown at 44 and 46 in FIGS. 5A and 5B, the grating period may be changed to be Δ₂=2Δ₁ by pairing adjacent ribbons. If the values of Δᵢ, ζᵢ, and αᵢ are properly chosen, the first order response angle for the signal λ₂ using a grating period of Δ₂, will be the same as for λ₁ using the grating period Δ₁ (of, for example, 3-5 microns). Similarly, the grating period may be changed to be Δ₂=2Δ₁ as shown at 48 in FIGS. 5A and 5B, and with properly chosen values for Δᵢ, λᵢ, and αᵢ the first order response angle for the signal λ₃ using a grating period of Δ₃, will be the same as for λᵢ using the grating period Δ₁.

The grating period of an active second modulator therefore, may be changed to re-direct the modulated illumination field to the correct location on the imaging surface in the event that the frequency of the illumination source is slightly offset from the desired frequency. In further embodiments, the second modulator may be used to correct for errors in intensity of portions of the modulated field. In still further embodiments a third or more modulators may be used to correct for different types of errors in the modulated illumination field.

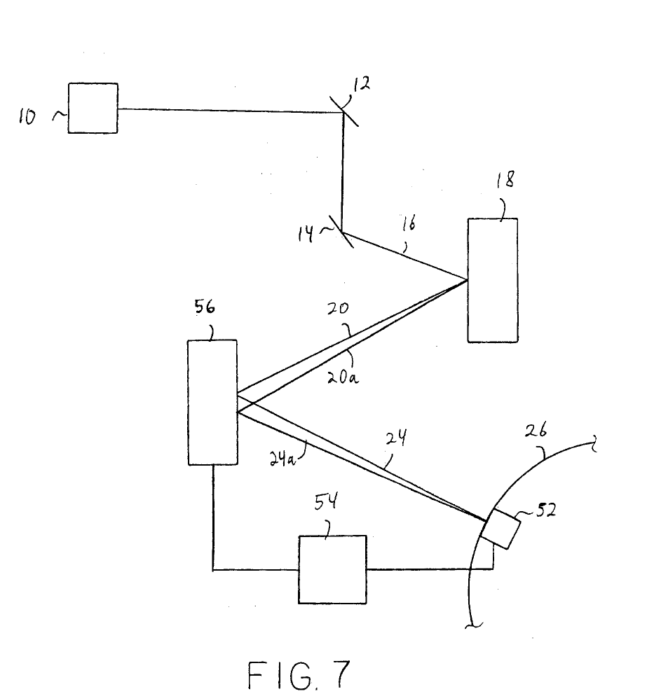

As shown in FIG. 7, another embodiment of the invention further includes a detector 52 that is positioned adjacent one end of the imaging surface 26 and controller 54 that is coupled to the detector 52 as well as an active second modulator 56. When a misdirected modulated illumination field 20a is reflected by the second modulator 56, the reflected modulated illumination field 24a is received by the detector 52 and an error signal is provided to the controller 54. The controller 54 then directs the modulator 56 to apply a correction to the modulated illumination field to correct for the error, and the reflected modulated illumination field 24a is then directed toward the correct location as determined by the detector 52. The system may then proceed with normal imaging.

Those skilled in the art will appreciate that numerous modifications and variations may be made to the above disclosed embodiments without departing from the spirit and scope of the present invention.

What is claimed is:

1. An illumination modulation system for producing modulated illumination for an imaging system, said illumination modulation system comprising:
a first modulator for receiving illumination from an illumination source and for producing modulated illumination; and
a second modulator for receiving said modulated illumination and for producing corrected modulated illumination for imaging.

2. The illumination system as claimed in claim 1, wherein said system further includes a detector for determining whether an illumination signal includes a plurality of distinct closely spaced frequencies.

3. The illumination system as claimed in claim 1, wherein said system further includes a detector for determining whether the intensity of at least a portion of said modulated illumination is a desired intensity.

4. The illumination system as claimed in claim 1, wherein said system further includes a detector for receiving said modulated illumination and for producing an error signal, said second modulator for correcting said modulated illumination responsive to said error signal.

5. The illumination system as claimed in claim 1, wherein said first modulator is a grating light valve.

6. The illumination system as claimed in claim 1, where said second modulator is a passive modulator.

7. The illumination system as claimed in claim 6, where said second modulator is a diffraction grating.

8. The illumination system as claimed in claim 1, where said second modulator is an active modulator.

9. The illumination system as claimed in claim 8, where said second modulator is a grating light valve.

10. An imaging system for providing imaging illumination at a recording medium, said imaging system including:
an illumination source for producing a line of laser illumination;
a first modulator for receiving said line of laser illumination and for producing modulated illumination; and
a second modulator for receiving said modulated illumination and for producing corrected modulated illumination for imaging.

11. The imaging system as claimed in claim 10, wherein said illumination source includes laser diodes.

12. The imaging system as claimed in claim 10, wherein said system further includes a detector for determining whether an illumination signal includes a plurality of distinct closely spaced frequencies.

13. The imaging system as claimed in claim 10, wherein said system further includes a detector for determining whether the intensity of at least a portion of said modulated illumination is a desired intensity.

14. The imaging system as claimed in claim 10, wherein said system further includes a detector for receiving said modulated illumination and for producing an error signal, said second modulator for correcting said modulated illumination responsive to said error signal.

15. The imaging system as claimed in claim 10, wherein said first modulator is a grating light valve.

16. The imaging system as claimed in claim 10, where said second modulator is a passive modulator.

17. The imaging system as claimed in claim 16, where said second modulator is a diffraction grating.

18. The imaging system as claimed in claim 10, where said second modulator is an active modulator.

19. The imaging system as claimed in claim 18, where said second modulator is a grating light valve.

20. A method of providing imaging illumination at a recording medium, said method including the steps of:
providing a line of laser illumination;
receiving said line of laser illumination;
producing modulated illumination;
receiving said modulated illumination; and
producing corrected modulated illumination for imaging.

21. The method as claimed in claim 20, wherein said step of producing modulated illumination for imaging includes modulating a grating light valve.

22. The method as claimed in claim 20, wherein said step of producing corrected modulated illumination for imaging includes modulating a grating light valve.
